(19) United States
(12) Patent Application Publication
(10) Pub. No.: US 2005/0137850 A1
(43) Pub. Date: Jun. 23, 2005

(54) Method for automation of programmable interfaces

(75) Inventor: Robert M. Odell, Hillsboro, OR (US)

Correspondence Address: MARGER JOHNSON & McCOLLOM, P.C., 1030 S.W. Morrison Street, Portland, OR, 97205, US

(73) Assignee: Intel Corporation, Santa Clara, CA (US)

(21) Appl. No.: 10/753,192

(22) Filed: Dec. 23, 2003

(51) Int. Cl. G06F 17/28

(52) U.S. Cl. 704/4

(57) ABSTRACT

A file includes data and semantic context. The semantic context identifies limitations on the use of the data in the file. Semantic context may include, among other possibilities, source information about a parameter, acceptable values for a parameter, presentation information, a record of the use of the data, and information to synchronize the use of the data with another file.

### FIELD OF THE INVENTION

This invention pertains to networks, and more particularly to enhancing programming interfaces in networks.

### BACKGROUND OF THE INVENTION

As originally designed, the Internet is a static concept. Although new content may be made available and accessed using the appropriate Uniform Resource Locator (URL), each page remains a static object, fixed until someone manually changed it.

To address the static nature of the Internet, new tools have become available. An early concept that allowed for some variation in content, depending on the user, was the Common Gateway Interface (CGI) script. CGI scripts allowed content providers to access applications and use the results of the application in a carefully formed web page. CGI scripts are an example of a programming interface: they allow end users to access data that is not static in nature, and see the results across the Internet. But CGI scripts are limited in their functionality.

More generally, it is now possible to access applications written in a variety of programming languages using a remote procedure call. The remote procedure call translates a web document into a call to a particular function offered by a service, so that the results may be generated and returned to the caller.

One way to make remote procedure calls is using a Simple Object Access Protocol (SOAP) document. A SOAP document is typically an eXtensible Markup Language (XML) document that may be used for two-way messaging. A number of SOAP documents (and the associated remote procedure calls) may then be grouped together to form a service. (The remote procedure calls may be related in some way, as desired, may be a set of unrelated remote procedure calls, or something in between.)

To make the service accessible and advertised (so that the web service application is known and used), a Web Service Description Language (WSDL) document is stored with the service. The WSDL document describes the services as completely as possible. The WSDL document exposes the available function calls, the parameters each function takes, the data types used, and so on. Like SOAP documents, WSDL documents are typically stored in XML.

Completing the exposure of the web service application is the Universal Description, Discovery, and Integration (UDDI) framework. UDDI allows a client to determine what remote procedure calls are available at various service providers. UDDI takes the WSDL documents for various services, and makes their content available to anyone interested in using the services.

Remote procedure calls have limits in how they may be used. For example, each remote procedure call is separate and distinct. That is, there is no way to represent a logical relationship between remote procedure calls. In addition, each remote procedure call has to check that the values provided for the parameters satisfy any limitations imposed by the remote procedure call. Remote procedure calls offer no techniques for guaranteeing that specific parameters are present, or to offer default values for parameters. Finally, remote procedure calls provide no information about how they may be presented to users via a user interface.

Another difficulty with remote procedure calls lies in interpreting them after execution. There is nothing that links a remote procedure call with its eventual result. The results also do not provide any metadata, such as when the remote procedure call was made, or how different remote procedure calls may be synchronized.

The invention addresses these problems and others in the art.

### BRIEF DESCRIPTION OF THE DRAWINGS

FIG. 1 shows a computer utilizing services across a network, according to an embodiment of the invention.

FIGS. 2A-2B show an architecture used for providing access to services across a network, according to an embodiment of the invention.

FIG. 3 shows a file with a context applicable to the data on the computer of FIG. 1, according to an embodiment of the invention.

FIGS. 4A-4D show an example of a prior art WSDL document.

FIGS. 5A-5G show various attached semantic contexts applicable to the WSDL document of FIGS. 4A-4D within the architecture of FIGS. 2A-2B, according to an embodiment of the invention.

FIG. 6 shows an example of a prior art SOAP document.

FIGS. 7A-7B show various execution semantics applicable to the SOAP document of FIG. 6, according to an embodiment of the invention.

FIG. 8A shows an execution context indicating that the SOAP client should wait for a notify event before continuing execution on the computer of FIG. 1, according to an embodiment of the invention.

FIG. 8B shows a notify event annotated with an execution context that satisfies the waiting execution context of FIG. 8A, according to an embodiment of the invention.

FIGS. 9-15 show a flowchart of the procedure for enforcing a semantic context to a file on the computer of FIG. 1, according to an embodiment of the invention.

FIGS. 16-20 show a flowchart of the procedure for adding an execution context to a file on the computer of FIG. 1, according to an embodiment of the invention.

### DETAILED DESCRIPTION OF THE PREFERRED EMBODIMENT

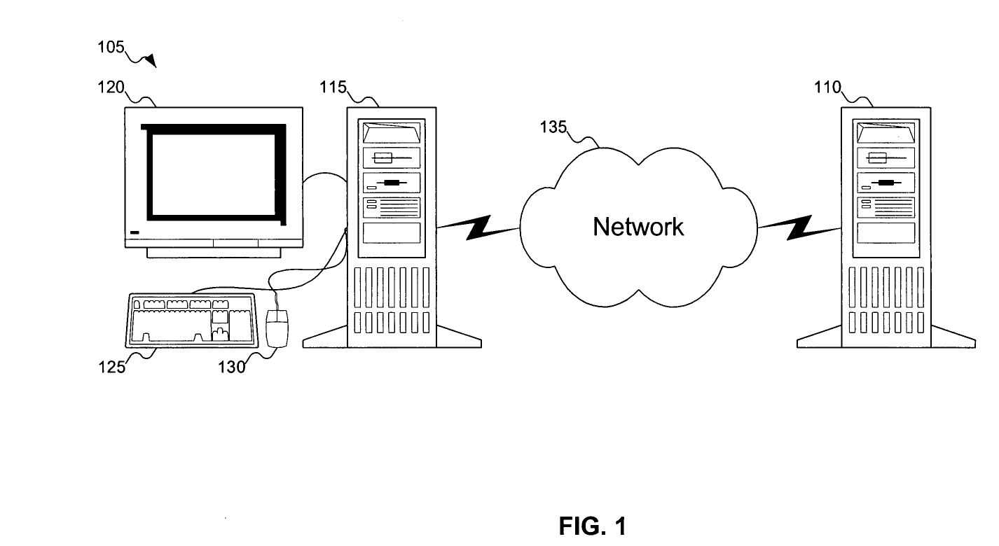

FIG. 1 shows a computer utilizing services across a network, according to an embodiment of the invention. In FIG. 1, computer system 105 is a client, taking advantage of services offered via computer 110. Computer system 105 is shown as including computer 115, monitor 120, keyboard 125, and mouse 130, but a person skilled in the art will recognize that computer system 105 may omit components shown and may include components not shown. For example, computer system 105 might omit mouse 130, and include a printer. A person skilled in the art will also recognize that computer system 105 may be a server, rather than a computer system accessed by end-users.

Computer system 105 is connected to computer 110 via network 135. Network 135 may be any variety of network. For example, network 135 may be an Ethernet (either Megabit or Gigabit Ethernet) network, or a wireless network utilizing Bluetooth or any of the IEEE 802.11a/b/g standards, among others. (The Bluetooth standard may be found at “http:www.bluetooth.comdev#specifications.asp,” and the IEEE 802.11a-1999 (published in 1999), IEEE 802.11b-1999, IEEE 802.11b-1999/Corl-2001 (published in 1999, corrected in 2001), and IEEE 802.11g-2003 (published in 2003) standards may be found online at “http:standards.ieee.orgcatalog#olis#lanman.html” (to avoid inadvertent hyperlinks, forward slashes (“/”) in the preceding uniform resource locators (URLs) have been replaced with pound signs (“#”)).

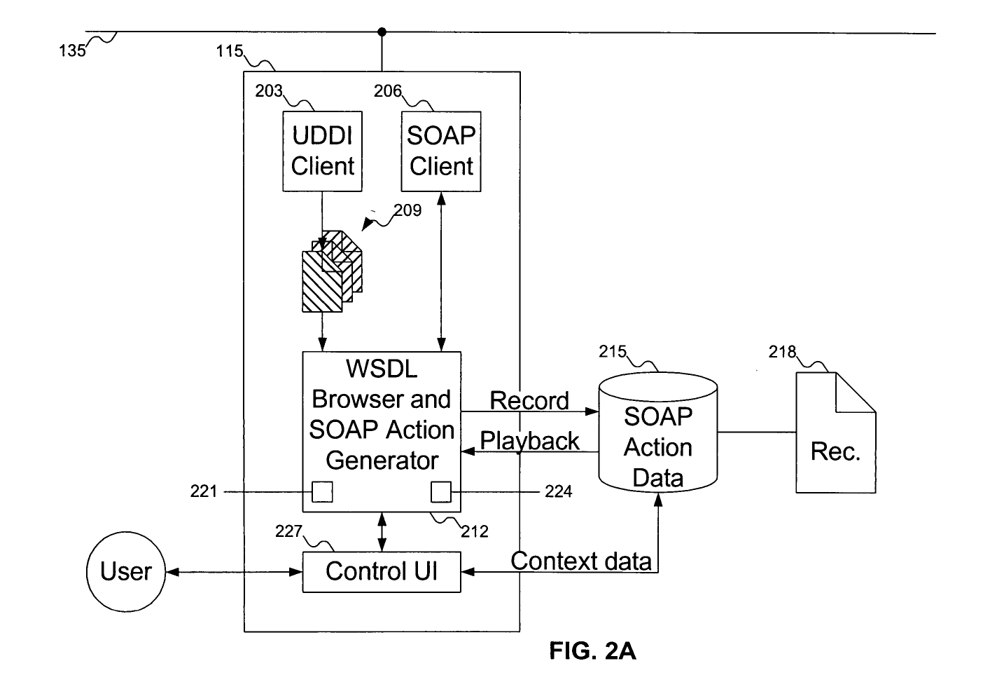

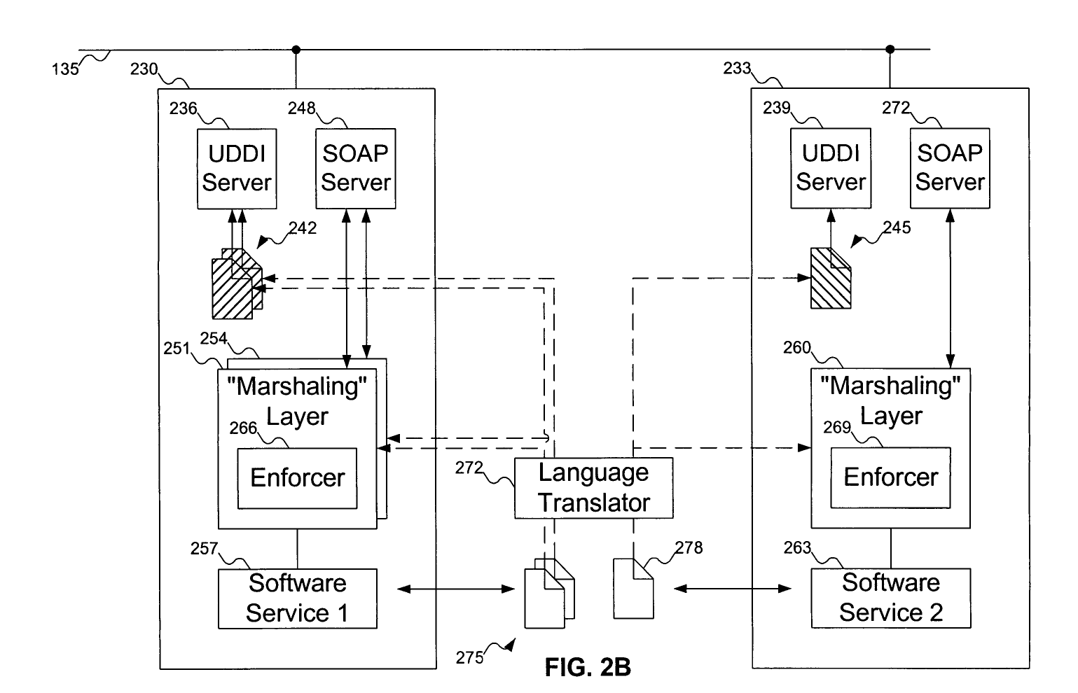

FIGS. 2A-2B show an architecture used for providing access to services across a network, according to an embodiment of the invention. In FIG. 2A, the details of computer 115 of FIG. 1 are shown. Computer 115 is a client of the services, offered by the servers of FIG. 2B (discussed below), and which provides information about the services to client computers.

Computer 115 includes Universal Description, Discovery, and Integration (UDDI) client 203 and Simple Object Access Protocol (SOAP) client 206. UDDI client 203 is responsible for collecting the Web Service Description Language (WSDL) documents stored on servers offering services. For example, UDDI client 203 has collected WSDL documents 209 from UDDI servers (discussed with reference to FIG. 2B below). SOAP client 206 is responsible for sending SOAP documents to SOAP servers, thereby utilizing services offered by SOAP servers.

WSDL browser 212 is responsible for browsing WSDL documents 209 to determine a service to utilize. It is also responsible for generating SOAP actions, which are sent via SOAP client 206 to the appropriate SOAP server. In addition, the generated SOAP actions (and the results received from the SOAP server) may be stored in SOAP action data 215, for example, as record file 218, using recorder 221. (SOAP actions and SOAP results are collectively referred to as SOAP documents.) This enables the system to repeat (or replay) prior execution of remote procedure calls made previously, by sending logically equivalent SOAP actions to the SOAP server. In effect, the system recreates the logical sequence of remote procedure calls made to the SOAP server.

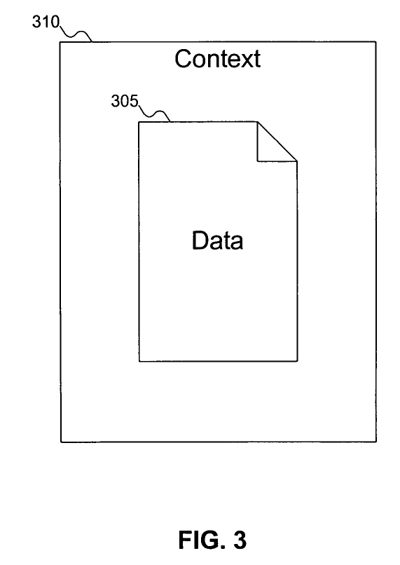

WSDL browser 212 includes enforcer 224. Enforcer 224 is responsible for enforcing that any semantic or execution contexts in SOAP actions are satisfied. This is discussed further with reference to FIG. 3 below.

To provide a way for users to interact with the service, a user interface is typically used: for example, as part of a web browser. The user interface may offer users the opportunity to select the remote procedure call to execute, may allow users to provide input to the remote procedure call, and may present output from the remote procedure call to the user.

To support this user interface, a control user interface 227 is responsible for generating the user interface that may be viewed by the user. Control user interface 227 uses an internal representation of WSDL browser 212 for WSDL documents 209, takes information about the remote procedure calls and other features of the various services, and prepares a user interface. This user interface provides users with a convenient and easy way to utilize the services offered.

FIG. 2B shows servers 230 and 233 offering various services that may be utilized by computer 115. Servers 230 and 233 may be examples of server 110 in FIG. 1. Each server offers a UDDI server and SOAP server component. The UDDI server components (236 and 239, respectively) are the server equivalents to UDDI client 203 (described above with reference to FIG. 2A). The UDDI server components receive requests for WSDL documents and return the requested WSDL documents to the requester. For example, UDDI server 236 return WSDL documents 242, and UDDI server 239 returns WSDL document 245. In a similar manner, the SOAP servers act as recipients for requests to use the services offered. For example, SOAP server 248 may receive requests for remote procedure calls from a SOAP client and return the results to the SOAP client.

The “Marshaling” layer acts as an intermediary between the SOAP server and the service. The “Marshaling” layer “translates” the SOAP documents (in eXtensible Markup Language (XML)) into function calls to the service. For example, “Marshaling” layers 251 and 254 act as interfaces to service 257, whereas “Marshaling” layer 260 acts as an interface to service 263. “Marshaling” layers 251 and 260 include enforcer 266 and 269, respectively, which enforce that semantic and execution contexts for the data within various files are satisfied. This is discussed further with reference to FIG. 3 below.

It may happen that there are multiple interfaces to a particular service. For example, in FIG. 2B, the reader may notice that there are two “Marshaling” layers to service 257. (Of course, there may be more than two interfaces to a particular service, if desired.) The reason for the second “Marshaling” layer is that two interfaces are provided to service 257, each using a different “Marshaling” layer. For example, service 257 may offer different remote procedure calls using the different interfaces. One embodiment of the invention supports managing multiple interfaces to the service.

Given that the services are defined in advance, language translator 272 may automatically generate “Marshaling” layers 251, 254, and 260, and WSDL documents 242 and 245. Language translator 272 takes software interface definitions 275 and 278, and uses these documents to automatically generate the “Marshaling” layers and WSDL documents. Software interface definitions 275 and 278 give complete definitions for the services they support. For example, software interface definitions 275 and 278 include the native definitions of the functions, including the names of the functions, and information about the parameter lists for the functions, among other things. In addition, software interface definitions 275 and 278 may be written using any desired imperative programming language (provided that language translator 272 may translate the language format used). For example, software interface definitions 275 and 278 may be a file used in implementing services 257 or 263, and that define the functionality of the services, such as a header file used in the C programming language. A person skilled in the art will recognize other formats that may be used for software interface definitions 275 and 278, and that software interface definitions 275 and 278 may be written in a format completely unrelated to the implementation of services 257 and 263 (although typically software interface definitions 275 and 278 are drawn from the implementation of services 257 and 263).

Notice that there are two software interface definitions 275 being used with language translator 272. Each software interface definition results in one “Marshaling” layer and WSDL document, as shown by the dashed arrows.

As described above, the SOAP and WSDL documents are typically stored using XML. XML offers applications that use XML files the ability to define their own elements and attributes, and to assign values to those attributes. When an application uses a document that includes XML elements that the application does not recognize, the application typically skips the unrecognized element. This means that additional elements may be added to XML files without affecting their utility to existing applications.

Embodiments of the invention take advantage of this capability of XML to impose contexts onto SOAP and WSDL documents. FIG. 3 shows a file, with data 305 “wrapped” by context 310 (although in a typical embodiment the context is interspersed with the data in a single file, without being immediately separable from the data). Data 305 may be either a SOAP document or a WSDL document, and context 310 varies depending on the type of data being wrapped. These contexts further define the use of the SOAP and WSDL documents.

Although the above discussion describes the addition of contexts to SOAP and WSDL documents in XML, a person skilled in the art will recognize that embodiments of the invention are limited neither to SOAP or WSDL documents nor to documents in XML. Instead, contexts may be wrapped around any data file, provided that the format of the file supports the contexts without limiting, such as by interfering with, the underlying functionality of the data file.

Semantic Context: Rules that Govern Use of Services

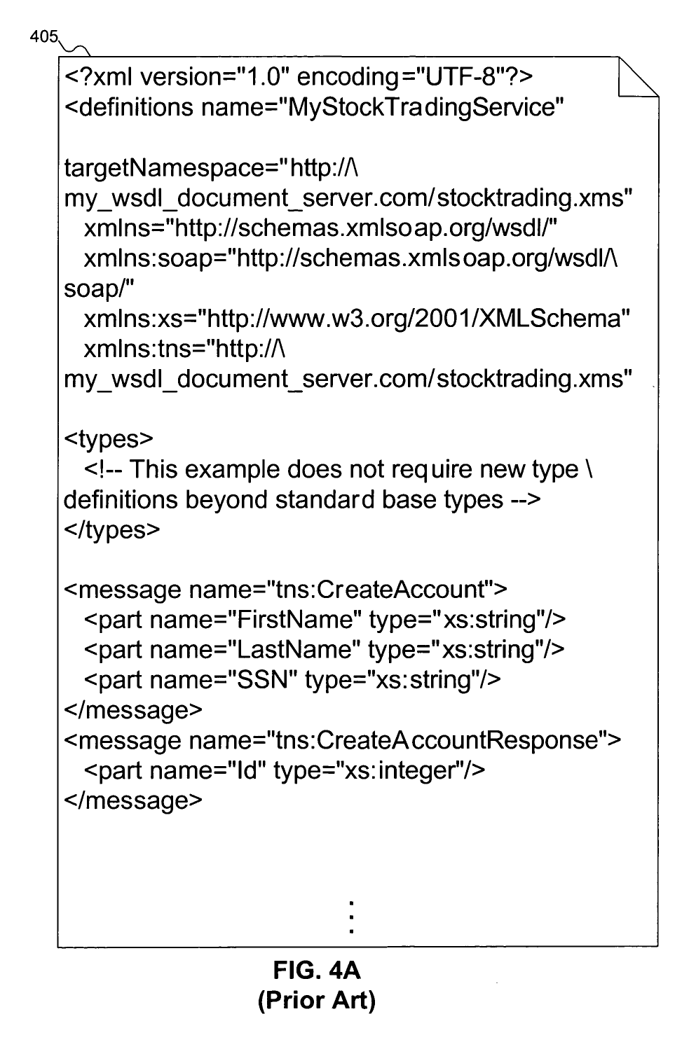

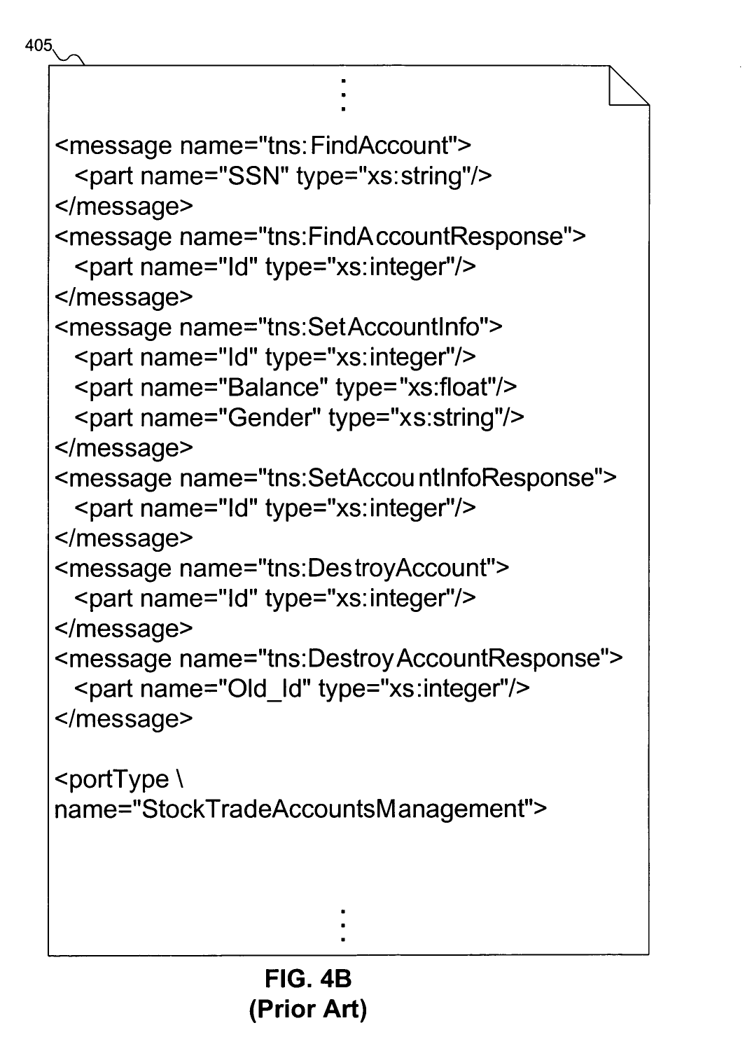

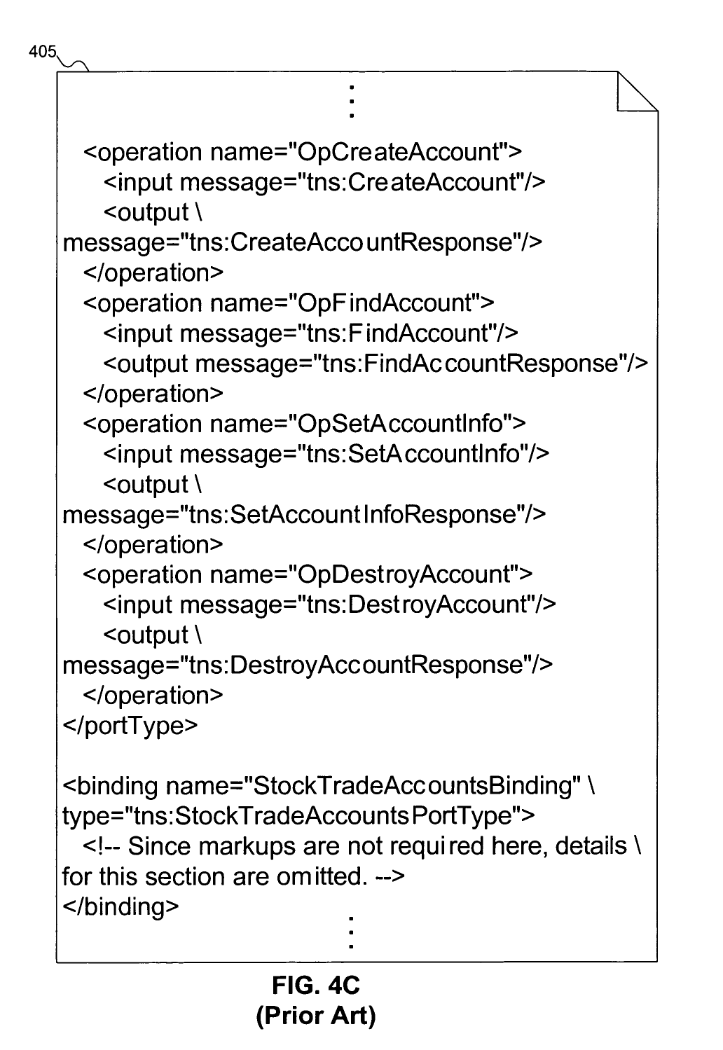

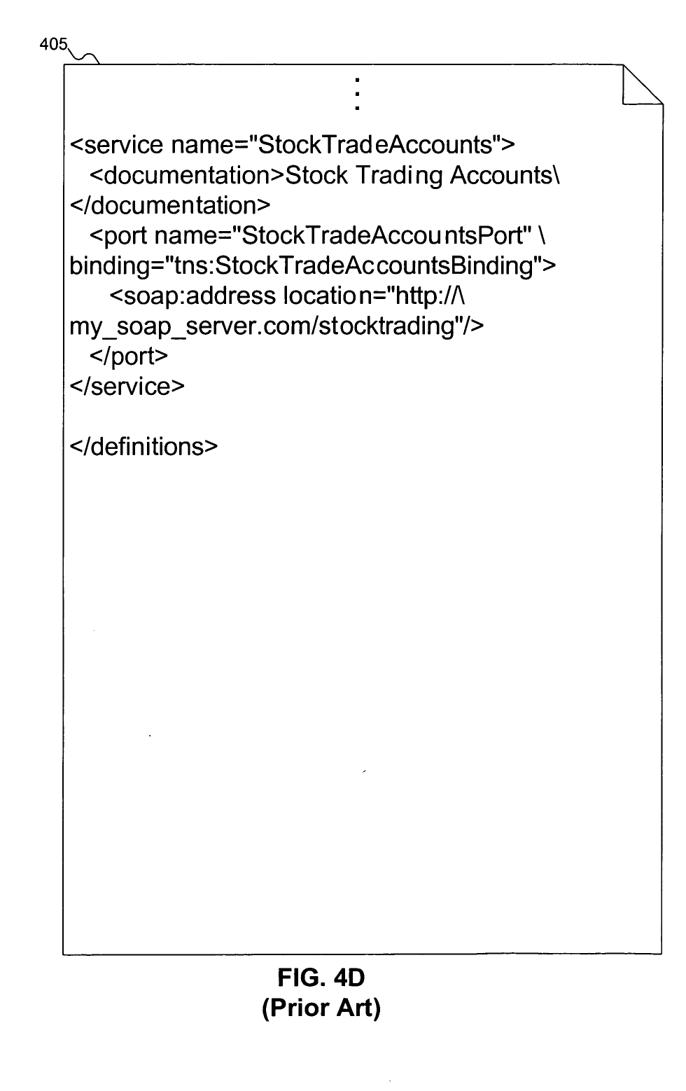

Before describing the types of contexts that may be used, it is helpful to see example documents to which they may be applied. FIGS. 4A-4D show WSDL document 405 for a service. (WSDL document 405 only shows details about pertinent portions of the document: portions of WSDL document 405 that are not affected by semantic contexts are not shown in detail.) WSDL document 405 describes a service for managing stock trading accounts. (WSDL document 405 is a simplistic model used to show the value of contexts, and does not fully implement a stock trading service.) As may be seen, WSDL document 405 describes four messages that represent services: creating an account, finding an account, setting an account balance, and destroying an account. WSDL document 405 also describes four messages that are responses to the services.

In FIGS. 4A-4D, and throughout the remainder of this document, backslashes (“\”) are used to mark lines of code that are split that might normally be placed on a single line, but a person skilled in the art will recognize how WSDL document 405 may be modified to describe a proper document.

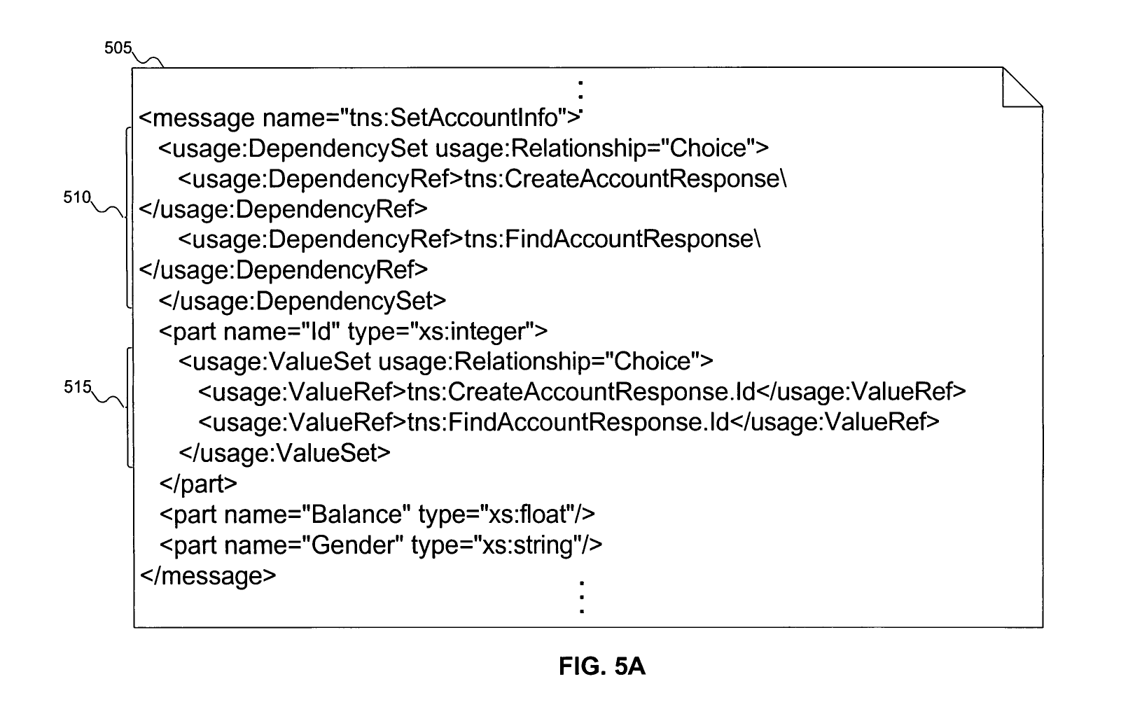

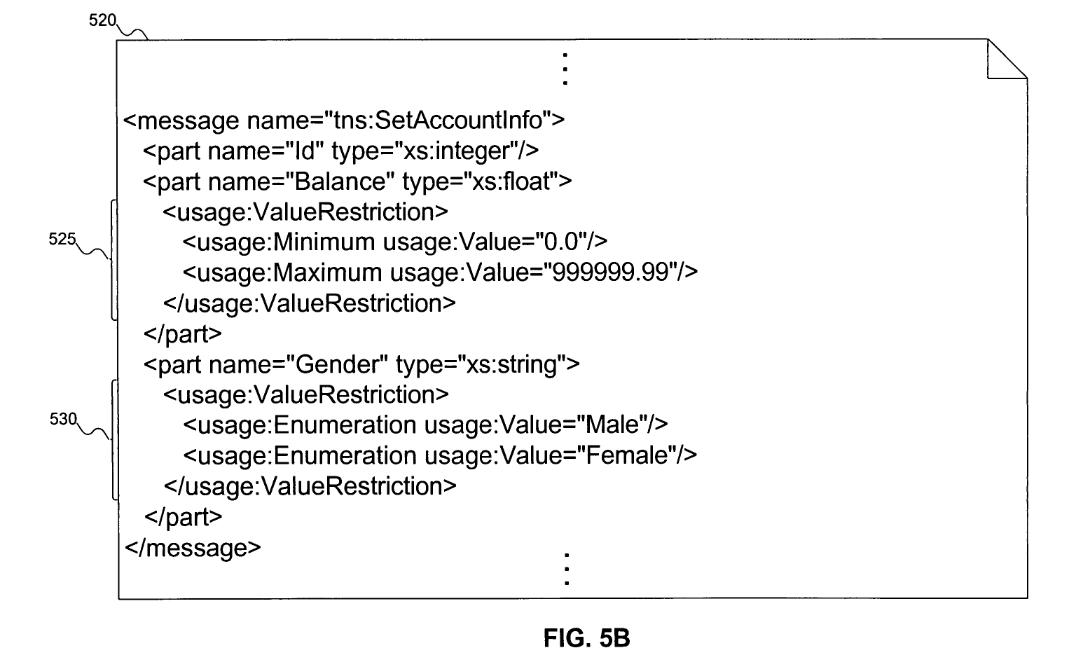

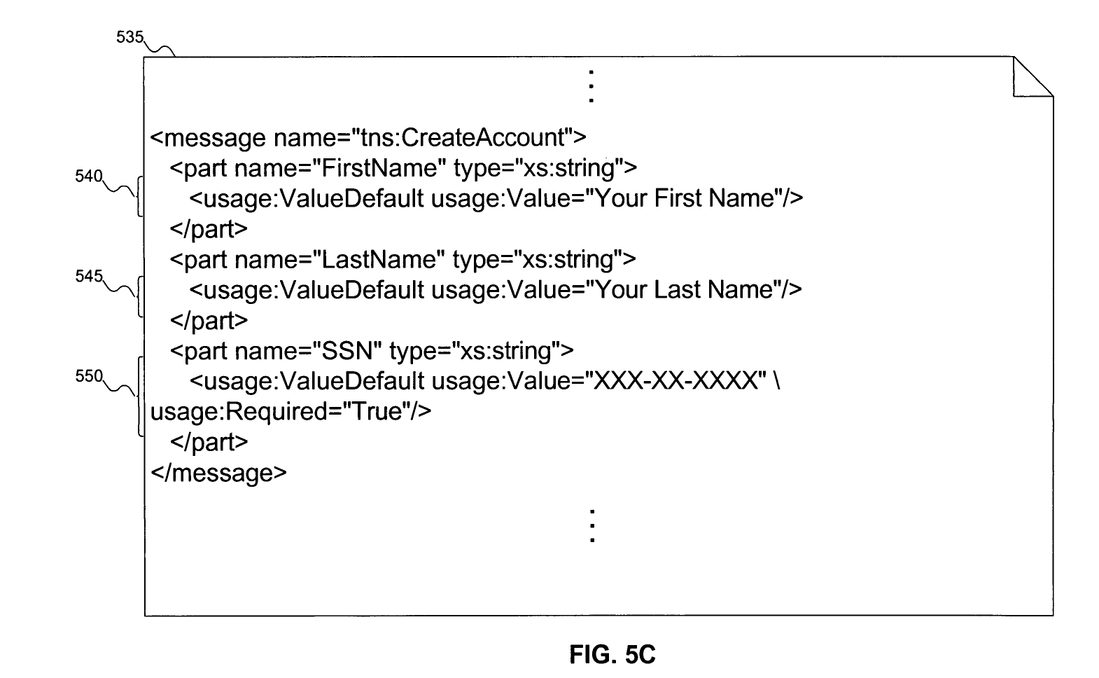

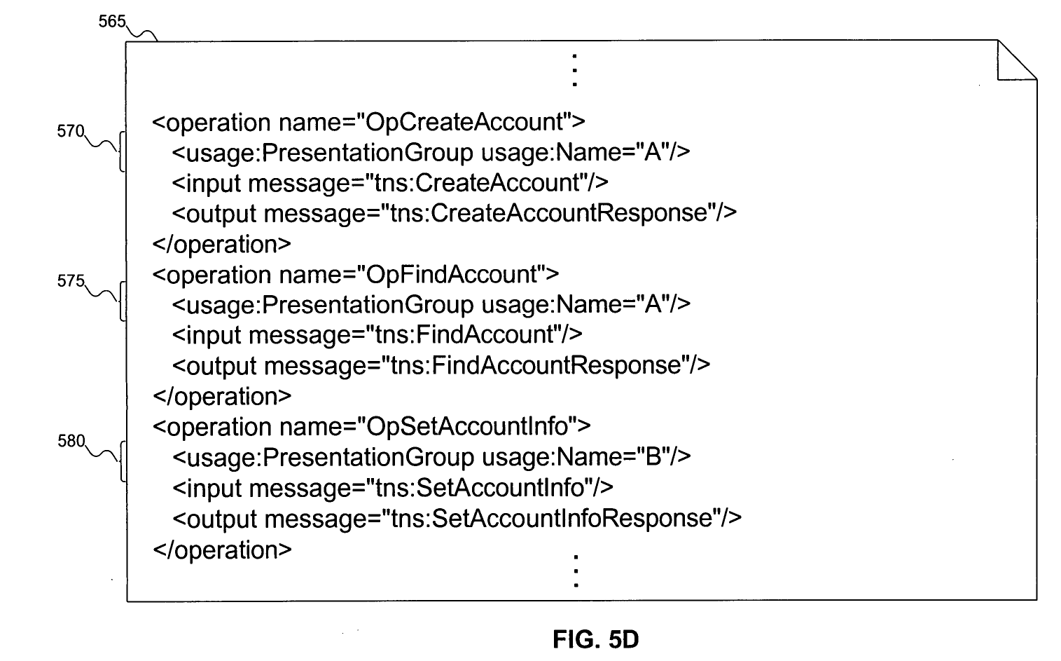

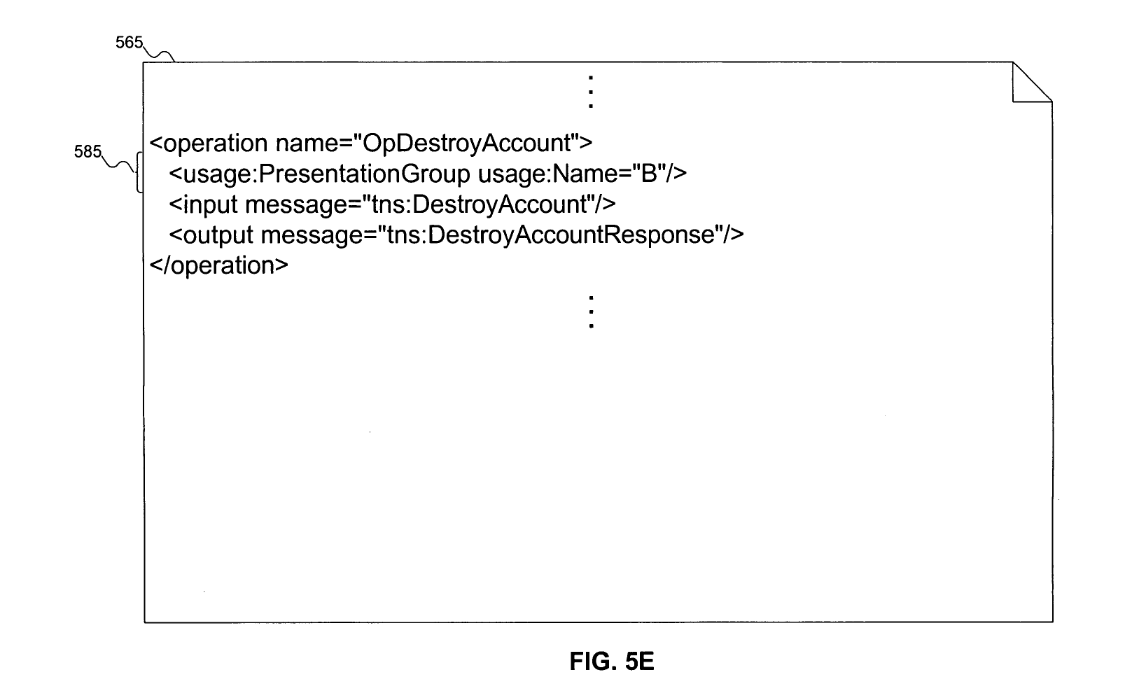

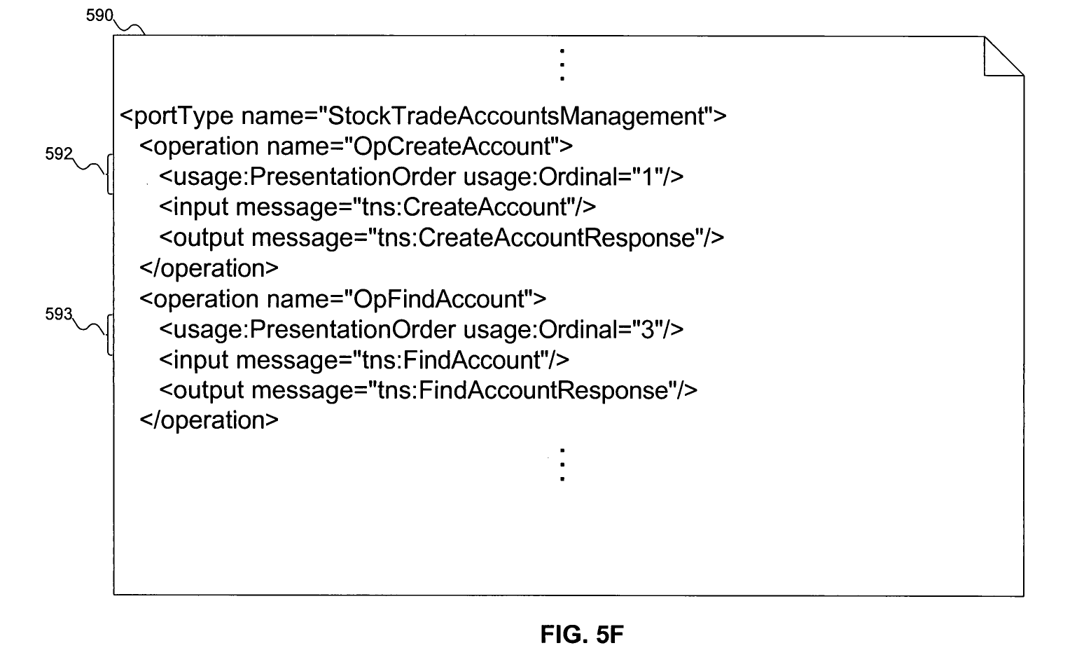

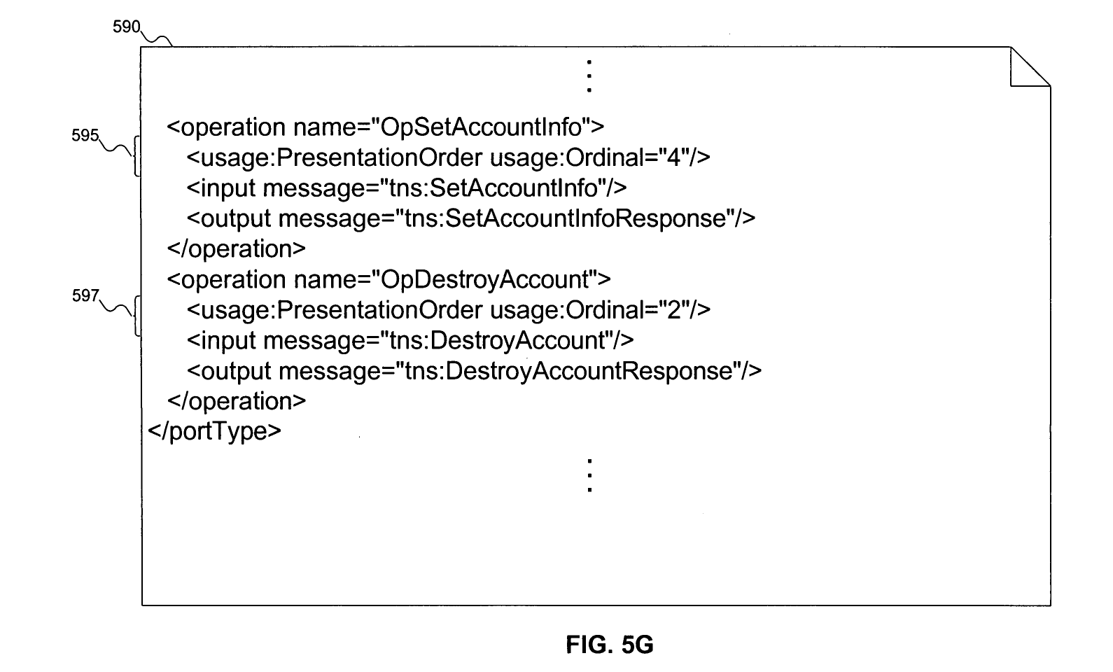

One context that may be used with WSDL documents manages the situation where one service (service B) expects that another service (service A) be called first. One situation in which this expectation may arise is where service A has some sort of side effect upon which service B depends. FIG. 5A shows how part of WSDL document 405 may be modified to describe the semantic that one service should be called before another. In FIG. 5A, WSDL document 505 shows the SetAccountInfo message, which is used to invoke the function that sets the account information, modified by the inclusion of block 510. (Although technically the message and the service the message triggers are distinct, throughout this document references to a message and the service/function the message invokes are treated as interchangeable.) In the remainder of this document, Block 510 indicates that the SetAccountInfo message depends one some other messages. Specifically, the SetAccountInfo message depends on either the CreateAccountResponse message or the FindAccountResponse message. That the SetAccountInfo message depends on either of the other messages is shown by the “Relationship=‘Choice’” attribute.

With the inclusion of block 510, the computer that is invoking the function may perform the indicated semantic check: that is, to make sure that before the SetAccountInfo function is called, either the CreateAccount function or the FindAccount function has been called. Using a semantic context simplifies the implementation of the service: instead of the service implementation having to check for proper semantics, this check may be left to the computer requesting the service. Using a semantic context may also improve the reliability of the service, as there may be some conditions that may be described semantically but not tested for in the service implementation. For example, a service that implemented a stack (a last-in, first-out queue) shared by all service requesters would need to be certain that every pop operation is preceded by a matching push operation. But the service implementation may only test to see if there is an element in the stack before popping the stack: the service has no way to know whether the particular computer requesting the pop operation had earlier requested a push operation. In contrast, a semantic requiring that a push be preceded by a matching pop is described in relatively few lines.

A person skilled in the art will recognize several facts after reviewing block 510. First, block 510 is merely exemplary as to how the semantic may be defined, and the semantic may be specified in other ways. For example, other tag names, attribute names, and values may be used. Second, while block 510 specifies that the SetAccountInfo message may depend on either of the CreateAccountResponse or the FindAccountResponse messages, in other situations a service may depend from exactly one other service, or from two or more other services (that is, two services both have to be invoked before this service may be called).

While it is useful to define the semantic requiring that the user create a new account or find an old account before setting some values in the account, the simple fact that the earlier service is called does not guarantee that the account created or found is the one being initialized. For example, the user might create a new account, but then accidentally supply the wrong account number when setting the account information. To address this concern, parameters of the function call to the service may also be given semantic significance. This is shown in block 515 of WSDL document 505.

In block 515, a source for the value provided to the Id parameter is indicated.

According to block 515, the value for the Id parameter is to be taken from either the Id parameter of either the CreateAccountResponse message or the FindAccountResponse message (these messages return via their Id parameter the number of the account created or located). In other words, the account whose info is being set should be the account most recently created or located. (Note that, by implication, the SetAccountInfo message depends on either the CreateAccountResponse message or the FindAccountResponse message, meaning that block 510 is redundant when used in light of block 515.)

Although block 515 shows a parameter depending just on the value of a parameter of another function, a person skilled in the art will recognize that the parameter can depend on other factors as well. For example, the parameter might receive a value that is a function of the other parameter from which it depends. The parameter might also depend on just one source, rather than the two source possibilities shown in block 515. More complicated arrangements are also possible: for example, depending on one or more functions of other parameters.

Another semantic context may provide limits to what values a parameter to the service may take. For example, when the user is setting up his account, his balance should not be negative initially. Such limits may be expressed using the semantic shown in FIG. 5B. In FIG. 5B, WSDL document 520 includes block 525, which sets limits for the value of the Balance parameter of the SetAccountInfo message. According to block 525, the value for the Balance parameter has a minimum value of 0.0, and a maximum value of 999999.99. So long as the value provided by the requester is in this range, the value is considered acceptable to the SetAccountInfo service.

Block 530 shows a different type of value limitation. The Gender parameter does not take numeric values; instead, it takes discrete values: specifically, “Male” or “Female.” Thus, rather than describing the value as having minimum and maximum values, acceptable values are enumerated.

A person skilled in the art will recognize that, while blocks 525 and 530 only show one range of values and one list of values (with only two values in the list), other ways of expressing limits on values are possible. For example, a parameter may be limited to the values 1, 3, and 5-7 by using an enumeration with three entries: 1, 3, and the range 5-7 (itself expressed using minimum and maximum tags or attributes).

Another use for semantics is to provide default values for parameters, or to indicate that a value is required for a parameter. FIG. 5C shows WSDL document 535 demonstrating these semantics. In blocks 540 and 545, default values are provided for the FirstName and LastName tags (respectively, “Your First Name” and “Your Last Name”). These default values may be presented to the user (e.g., through a user interface), which the user may then leave alone or replace with more fitting values. Admittedly, the default values provided in blocks 540 and 545 will not generally be correct, but may serve as a guide to the user, clueing the user in to what information needs to be provided.

Block 550 is slightly different. Although blocks 540 and 545 provide default values, nothing prevents the user from erasing the default values and not providing anything in their place. For example, the user might erase “Your First Name” as suggested by the user interface, but not provide the user's actual first name. In that case, the service would be called with no value provided for the FirstName parameter. Block 550 shows how this may be addressed by attaching an attribute indicating that a value is required for the parameter. Thus, for the SSN parameter, the user could enter his social security number, or leave the default social security number in place (which would not be accepted by the service, but that is a separate issue), but he may not try to execute the service without a social security number.

As opposed to providing limits on how the service may be used, another use for semantics in WSDL documents is to provide information about how the service calls are presented in a user interface. For example, various service calls may be grouped in a logical manner. Or, the service calls may be placed in specific locations in the user interface. A person skilled in the art will recognize other uses for semantics relative to user interfaces.

FIGS. 5D-5E shows how semantics may be used to group functions in a user interface. Each of the four operations, which combine a message sent by the requester and a reply back to the requester, is assigned to a presentation group. Then, in constructing a user interface (see control user interface 227 of FIG. 2A) for the user to access the services, the operations in the same presentation group may be placed together in the user interface. Thus, The Create Account and Find Account operations, both in presentation group A, may be grouped together, and the Set Account Info and Destroy Account operations, both in presentation group B, may be grouped together.

In contrast with FIGS. 5D-5E, FIGS. 5F-5G show the same operations being assigned ordinal markups for the semantics. The ordinal markups give the computer that builds the user interface information about how the operations should be prioritized. Note that this semantic does not establish an order in which the services must be called. Thus, while the Create Account operation has the highest ordinal, a customer who already has an active account would not want to be forced to create a new account: he would want to be able to access the existing account.

Not shown are semantics specifying positional information for the services. Such semantics may specify a location within the user interface where the described operation is shown. For example, the positional information might include coordinates relative to the top-left corner of the interface, measured in pixels. A person skilled in the art will recognize other ways in which positional semantics may be specified.

A person skilled in the art will recognize that the semantics relating to the display of the user interface tend to be suggestions, and not requirements. The services will operate without any problems even if the organization of the user interface does not conform to the presentational semantics provided. In contrast, semantics that specify information about the services themselves or their parameters often depend on the semantics being followed. The service may expect the client computer to enforce the semantics.

Although FIGS. 5A-5G show different semantic contexts, a person skilled in the art will recognize that they may be combined as desired. For the most part, the described semantic contexts (and typically, other contexts as well) are independent of each other. The only exception would be combining a semantic context storing positional information with other semantic contexts relating to the display of the user interface, as there would either be a conflict between the semantic contexts or one of the semantic contexts would be redundant.

Execution Context: Rules for Recording Execution of Services

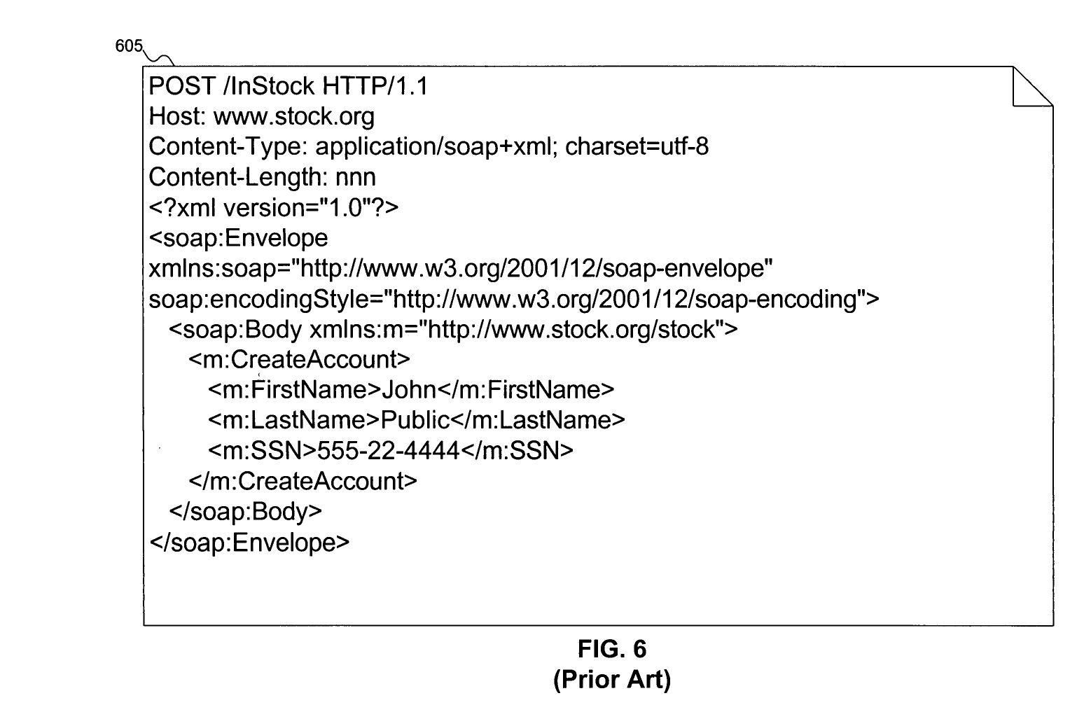

Before discussing the contexts applicable to SOAP documents, it is useful to consider an example of a SOAP document, such SOAP document 605 in FIG. 6. A SOAP document shows a communication relating to the service. Typically, one SOAP document is sent from the SOAP client (e.g., the user's computer) to the SOAP server (the server offering the service). As shown in FIG. 6, SOAP documents include some HTTP information as a header to the document, then include a section in a markup language (such as XML), containing the message itself. In FIG. 6, the message is a CreateAccount message, invoking the Create Account operation described above in the WSDL document of FIGS. 4A-4D. The message includes the three parameters, identified by tags, and the values provided for those tags. Thus, the provided first name is John, the provided last name is Public, and the provided social security number is 555-22-4444.

As described above with reference to FIG. 2A, the SOAP documents may be stored in SOAP action data 215. Thus, SOAP document 605, along with the result returned from the SOAP server and any other SOAP actions and results, may be retrieved from SOAP action data 215 as needed.

Whereas WSDL documents describe how to use an offered service, SOAP documents are the communications between the SOAP client and SOAP server in actually using the service. Thus, by the time the SOAP documents may be annotated with execution contexts, all of the data needed to invoke the service has been prepared. (For SOAP results, this is certainly the case, as the result is received by the SOAP client, and may only be annotated, after the service has been performed. In theory, for SOAP actions, the annotation may be made before the communication is sent to the SOAP server, but the annotation has no other impact on the SOAP action, and might as well not be there.) Thus, the difference between semantic contexts as used with WSDL documents and execution contexts as used with SOAP documents is that execution contexts provide information about the execution of the service call. But execution contexts are related to the semantic contexts of WSDL documents: as will be seen, execution contexts enable the recreation of a sequence of SOAP documents, and thus may be said to specify the source of data values used in the SOAP documents.

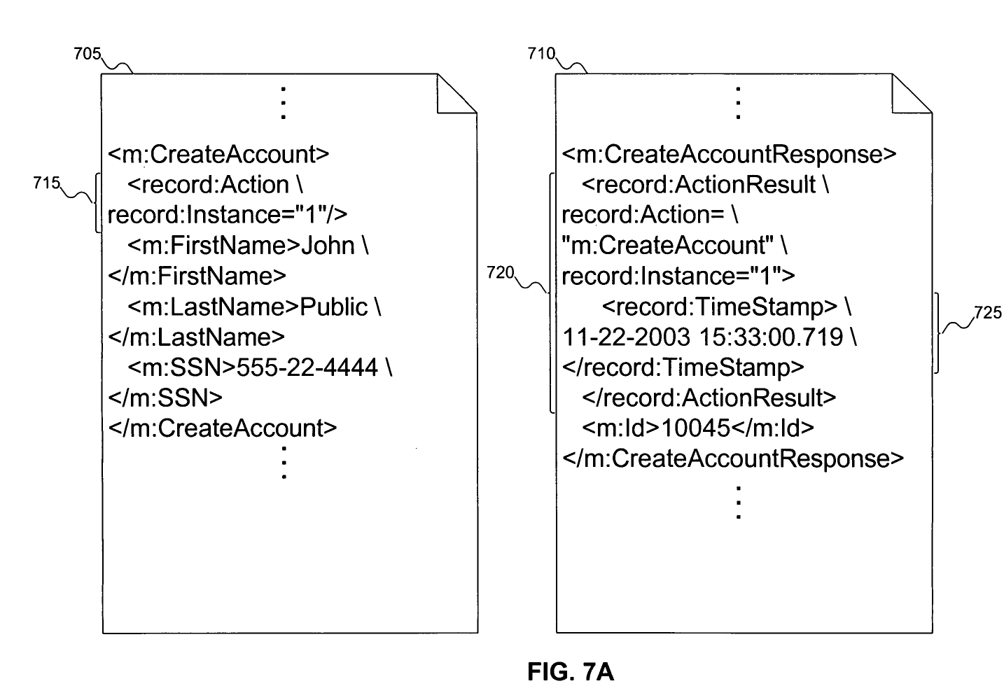

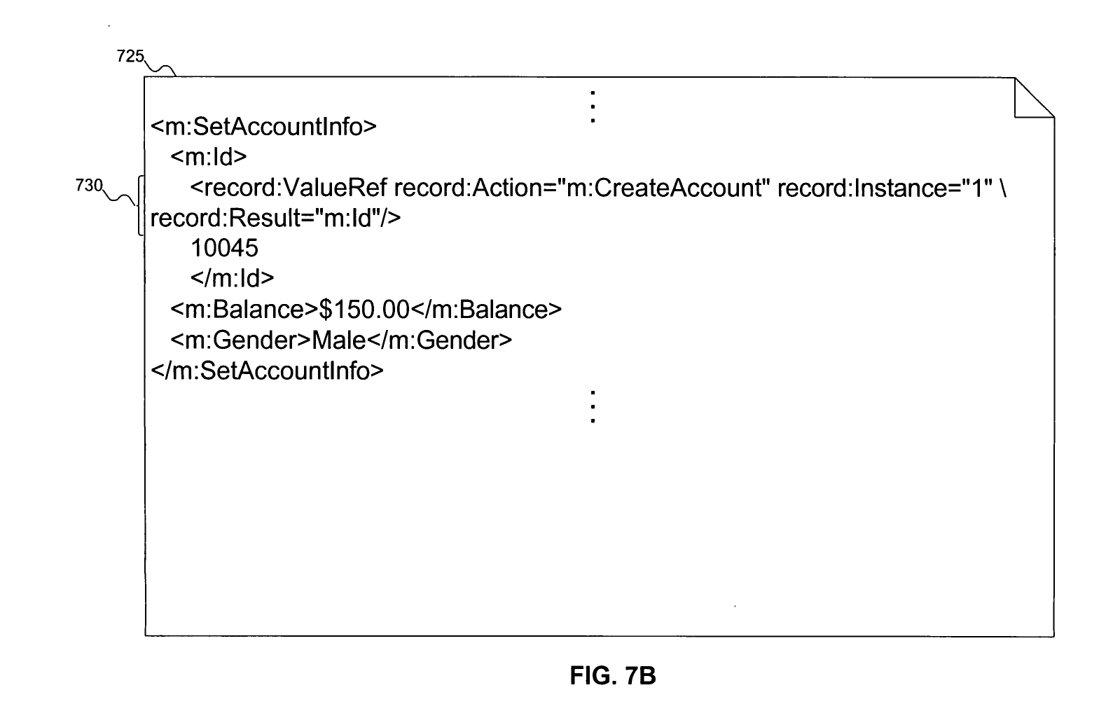

FIG. 7A shows SOAP documents 705 and 710. SOAP document 705 is a portion SOAP action 605 annotated according to an embodiment of the invention, and SOAP document 710 is a portion of the matching SOAP result. The only portions shown in SOAP documents 705 and 710 are the pertinent portions of the message that are annotated.

SOAP document 705 includes block 715, which adds an instance number to the message. As services typically do not provide any context of use, by annotating the SOAP action with an instance number (“1”), the corresponding SOAP result may later be found in the SOAP action data, provided the corresponding SOAP result is also annotated with the same instance number. This is shown in SOAP document 710, specifically in block 720. Note that block 720 includes the same instance number for the SOAP result as that of the SOAP action. If the same SOAP client later sends another Create Account message, that SOAP action (and the corresponding SOAP result) would be annotated with the next instance number (“2”). (Instance numbers are typically specific to a message, so a different message could also be annotated with instance number “1.” But a person skilled in the art will recognize that is also feasible to use different instance numbers for each message, if the messages are themselves different.)

Block 720 also shows a timestamp added to SOAP result. The timestamp identifies the date and time at which the SOAP result was received. Although block 720 shows both the instance number of the message and the timestamp, a person skilled in the art will recognize that the timestamp does not have to be coupled with the instance number: for example, block 715 includes the instance number, but no timestamp, and the reverse is also possible. (In practice, the instance number is almost always present, since it is used to link a SOAP action with the corresponding SOAP result, but in theory it may be omitted.)

As mentioned earlier, SOAP documents may be used to recreate the series of service calls. But it may happen that some of the data used in the earlier SOAP call may be out of date when attempting to recreate the SOAP sequence. For example, if the SOAP sequence includes a call to the Create Account service, in all likelihood the Id returned from the second call to the Create Account service will be difference from the Id returned from the first call. If later a call is made to a service to set the opening balance, the wrong Id would be used, and thus the wrong account would be configured (assuming that the service would allow the wrong account to be accessed at all). Thus, just using the data values without identifying where they come from would be insufficient to properly recreate the call sequence.

FIG. 7B shows an annotation to a message in SOAP action 725 to set the account information. Whereas the SOAP client does not know the opening balance and the user's gender until the user enters this information (that the gender might be deducible from the user's name is ignored here), the Id of the account has been encountered before. Specifically, the Id of the account was earlier found in the result of the SOAP action to create the account. Thus, block 730 may be annotated to the SOAP action. Block 730 indicates that the value for the Id parameter (“10045”) is taken from the Id parameter of the result of the CreateAccount message, instance number “1.” Then, when the SOAP actions are recreated, the SOAP client may use the Id parameter resulting from the repeated call to the Create Account service in the recreated call to the Set Account Info service, rather than using the wrong value for the Id parameter.

Another use for execution contexts is to synchronize activities occurring on multiple SOAP servers. While the stock account examples presented above have been easy to understand, the model used shows only a single server performing all of the actions. To describe how execution contexts may enable synchronization, a different model will be used. Internet Protocol (IP) telephony provides for communications that feel like standard telephones, but instead transmit data across some network (such as a local area network or the Internet). In an example embodiment that demonstrates establishing a call, the SOAP client first requests one service (service A) to place the call. (Several parts of the process are being glossed over here, to focus more on the execution context annotation.) The SOAP client may expect to receive a SOAP result from service A when it has finished placing the call. But the call is not completely established until service B notifies the SOAP client that it has received the call. Thus, the SOAP client must wait, not for the SOAP result from service A, but rather for the notification from service B.

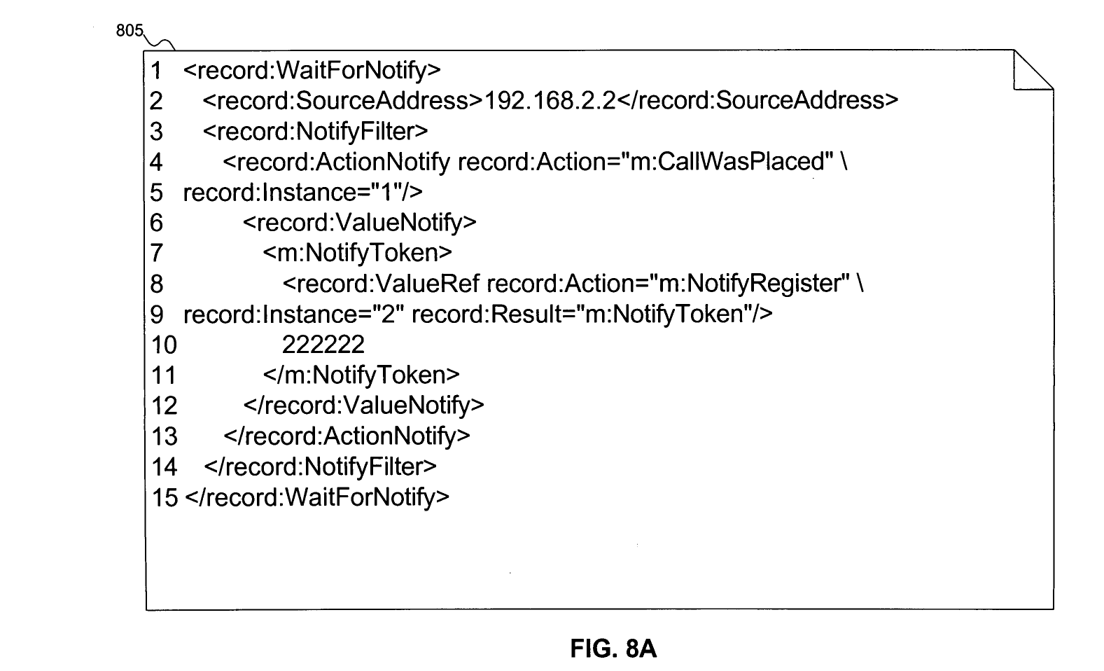

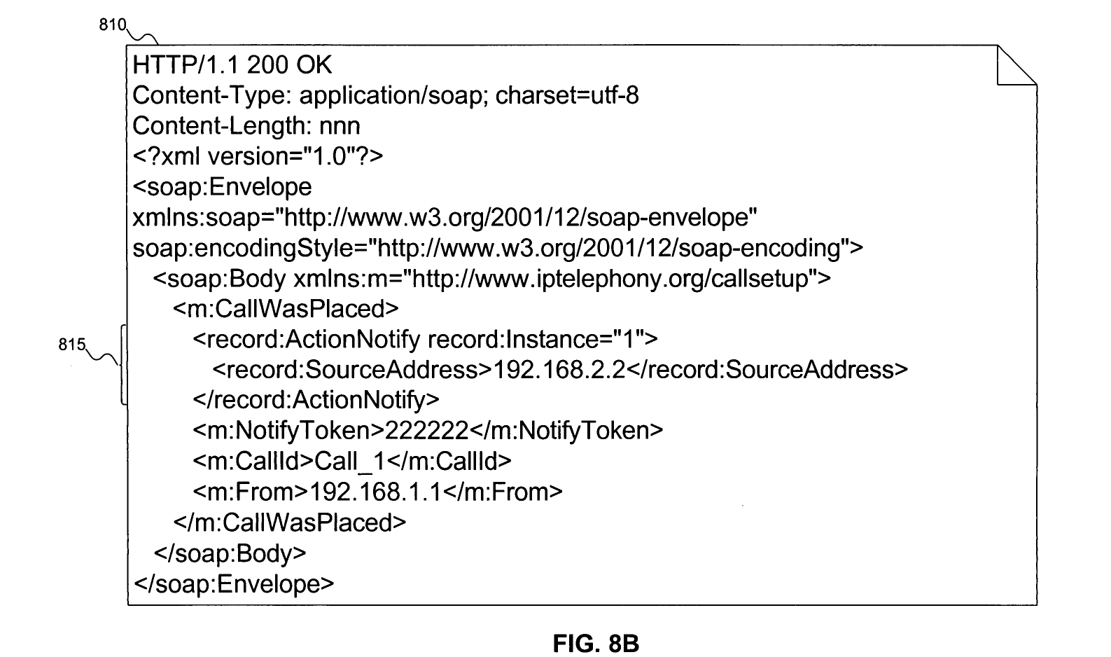

FIG. 8A shows execution context 805 used to cause the SOAP client, in recreating the telephone call, to wait for the notification from service B. Because of the complexity of this execution context (as compared with the other execution and semantic contexts), execution context 805 has the lines numbered, so that they may be individually described. Line 1 (and matching line 15) indicate that this entry in the SOAP action data is an instruction to wait for a particular notify event, before continuing to recreate the sequence of service calls. Line 2 indicates that the notify event is to come from a particular machine: the one with IP address 192.168.2.2.

Lines 3-14 provide additional information, that help refine exactly what notify event to wait for. After all, the SOAP server at IP address 192.168.2.2 might send several notify events to the SOAP client at around the same time, and the synchronization depends on the SOAP server indicating that it has received the call. Lines 4-5 indicate that the desired notify event includes a CallWasPlaced message, with the instance number “1.” Lines 7, 10, and 11 indicate that the CallWasPlaced message includes a particular token (called a Notify Token in FIG. 8A). As this value might change in a recreation of the service calls, is made a value reference in lines 8-9. Lines 8-9 reference back to an earlier SOAP result (not shown), where the SOAP client requested a Notify Token from SOAP server B, and is generated similar to the value reference described above with reference to FIG. 7B.

A careful reader may notice two interesting points about execution context 805. First, given the value reference in lines 8-9, the inclusion of the IP address of the SOAP server in line 2 is typically redundant. But line 2 should not contradict lines 8-9, and under some circumstances the notify event might not include a Notify Token. Thus, the inclusion of line 2 should do no harm, and may on occasion be useful.

Second, the reader might wonder how a specific instance number may be used for a message that has not yet been received. If the same SOAP client is waiting for multiple notify events with the same message, there is no way to know exactly what instance number will be assigned to the notify event for which execution context 805 is making the SOAP client wait. While it is true that when the SOAP client is waiting, it may not know what instance number will be assigned to the expected message, such information is known after the message is received. Recall that execution context 805 is used to synchronize a recreation of an earlier sequence of service calls. The instance number in lines 4-5 links execution context with the notify event in the SOAP action data: it does not mean that the SOAP client is supposed to wait for the first instance of the CallWasPlaced message. (It might help to realize that while the rest of execution context 805 may be created while the SOAP client is waiting for the notify event, at the very least, the instance number on lines 4-5 may not be added until after the SOAP client receives the notify event. Thus, the instance number, at least, is added after the synchronization is complete.)

FIG. 8B shows notify event 810, sent by the service receiving the telephone call, which completes the synchronization desired in execution context 805 of FIG. 8A. Note the annotation of block 815, which includes the assigned instance number (once assigned in block 815, the instance number may be added to lines 4-5 of execution context 805 in FIG. 8A, as discussed above). Block 815 also indicates the source of the notify event (this information is deducible from other sources, such as the source IP address of the communication, but that information is not part of the notify event that would be stored in the SOAP action data). Notice that the notify event also includes the Notify Token, with the same value as that included in line 10 of execution context 805. (Notify event 810 does not show the value reference to the SOAP action establishing the Notify Token (essentially, lines 8-9 of execution context 805 of FIG. 8A), but a person skilled in the art will recognize that notify event 810 may include a value reference as well.)

As with the semantic contexts described above with reference to FIGS. 5A-5G, the semantic contexts are independent of each other. Thus, the semantic contexts may be combined as desired.

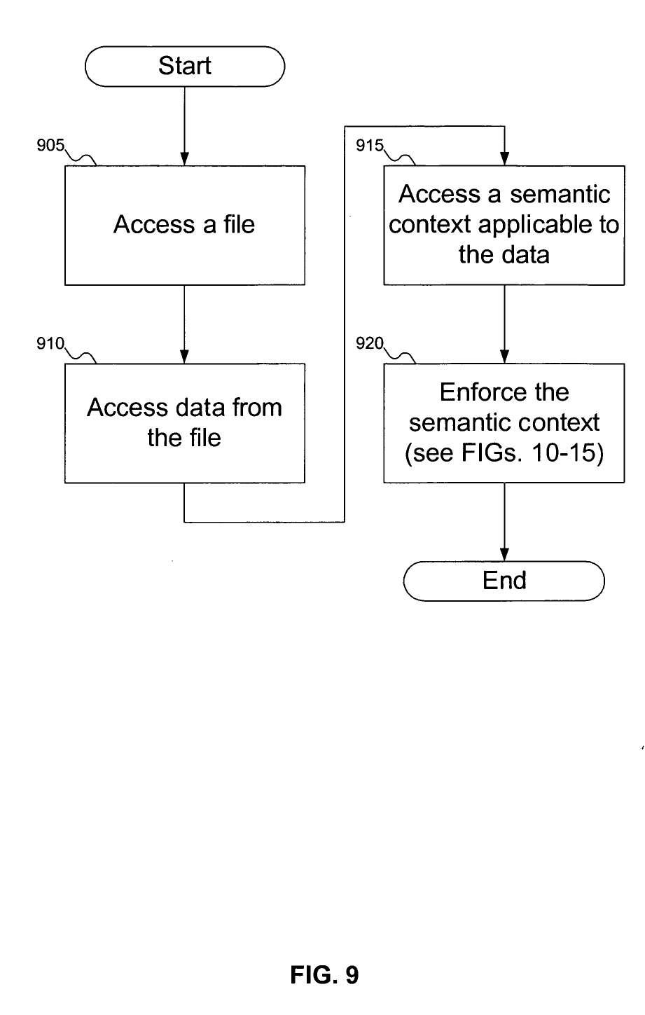

FIG. 9 shows a flowchart of the procedure for enforcing a semantic context. Recall that SOAP clients use semantic contexts to ensure that preconditions of the service call are satisfied, or to present the service calls to the user in an organized manner. Thus, the procedure shown in FIG. 9 is typically carried out on the computer of FIG. 1. At block 905, the computer accesses a file. At block 910, the computer accesses data from the file. At block 915, the computer accesses a semantic context applicable to the data. Finally, at block 920, the computer enforces the semantic context.

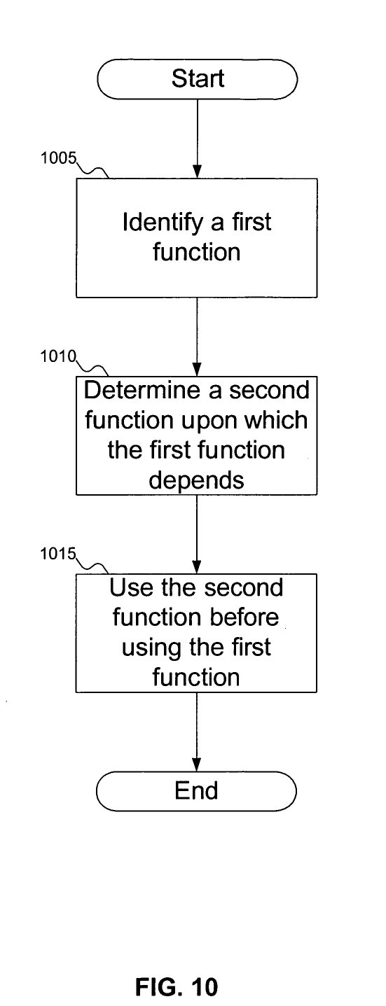

As the semantic context may take several different forms, FIGS. 10-15 show different flowcharts for the procedures for enforcing the different semantic contexts. FIG. 10 shows how functional dependencies are enforced. At block 1005, a first function is identified. At block 1010, a second function, upon which the first function depends, is determined. Finally, at block 1015, the second function is used before the first function, to satisfy the functional dependency.

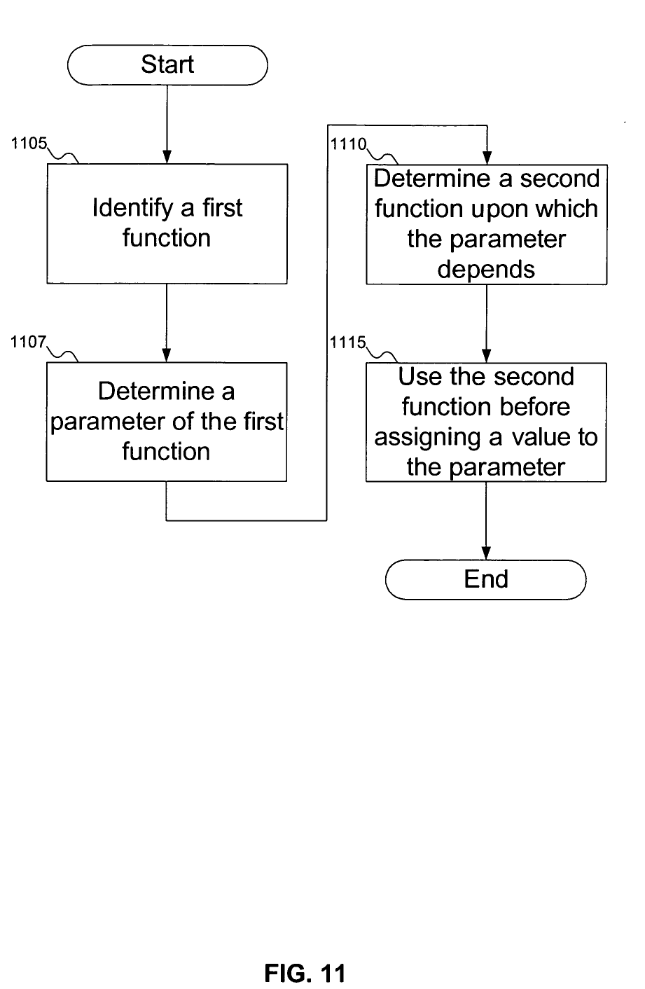

FIG. 11 shows how parameter dependencies are enforced. At block 1105, a first function is identified. At block 1110, a parameter of the first function is identified. At block 1115, a second function, upon which the parameter depends, is determined. Finally, at block 1120, the second function is used before a value is assigned to the parameter, to satisfy the functional dependency. Recall, with reference to FIG. 5A above, that this dependency may take the form of drawing the value for the parameter from a parameter of the second function. Then, block 1120 accesses the value for the parameter from the parameter of the second function.

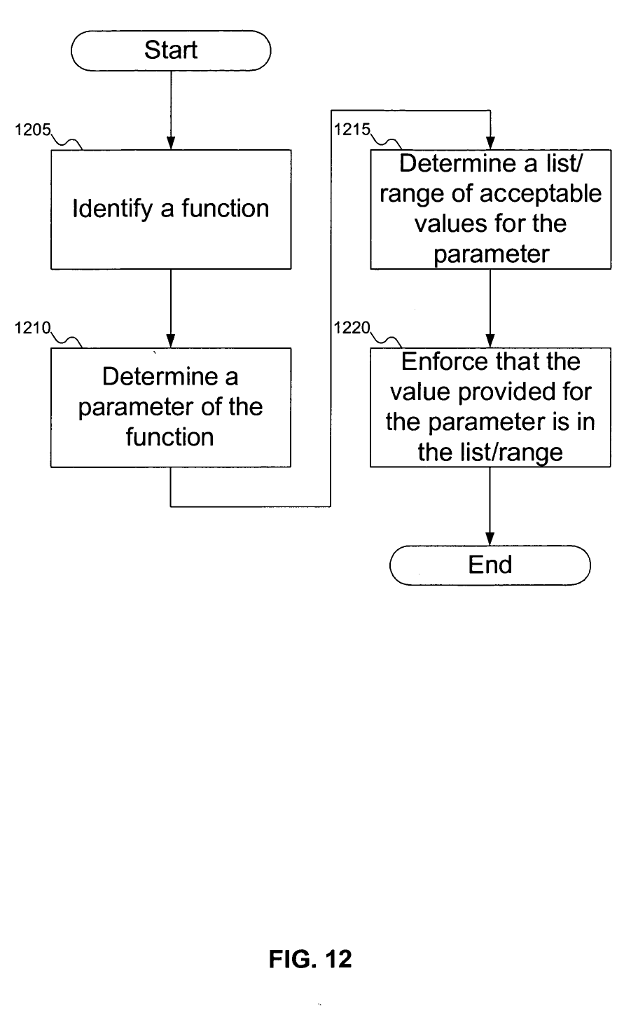

FIG. 12 shows how limits on parameter values are enforced. At block 1205, a function is identified. At block 1210, a parameter of the function is identified. At block 1215, a list or range of acceptable values for the parameter is determined. Finally, at block 1220, the value assigned to the parameter is limited to a value in the list or range of acceptable values.

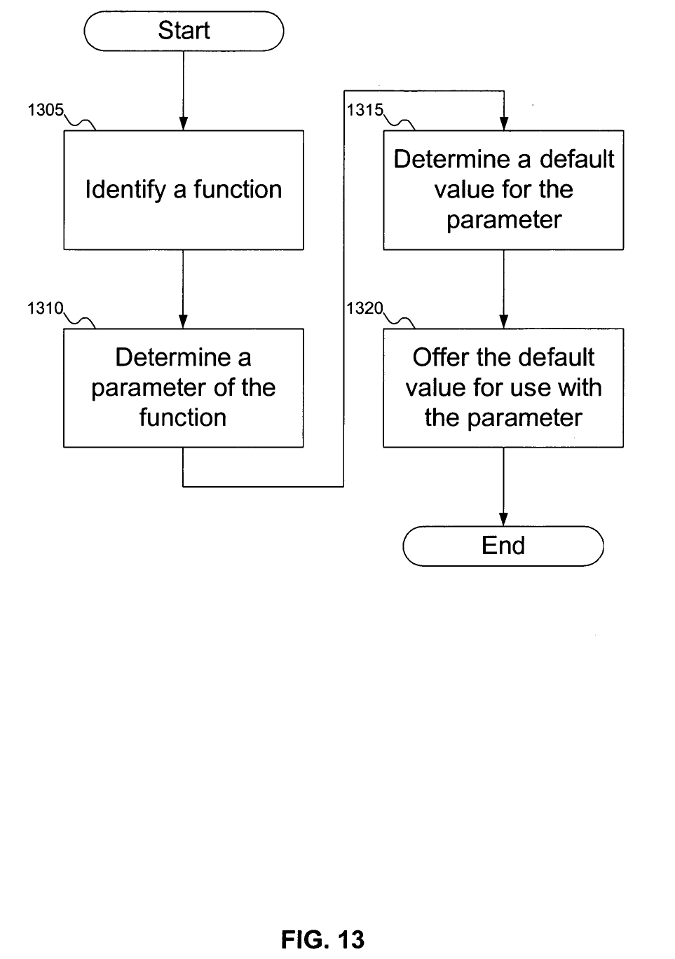

FIG. 13 shows how default values for parameters are enforced. At block 1305, a function is identified. At block 1310, a parameter of the function is identified. At block 1315, a default value for the parameter is. Finally, at block 1320, the default value is offered for use with the parameter, so that the user does not have to provide a value.

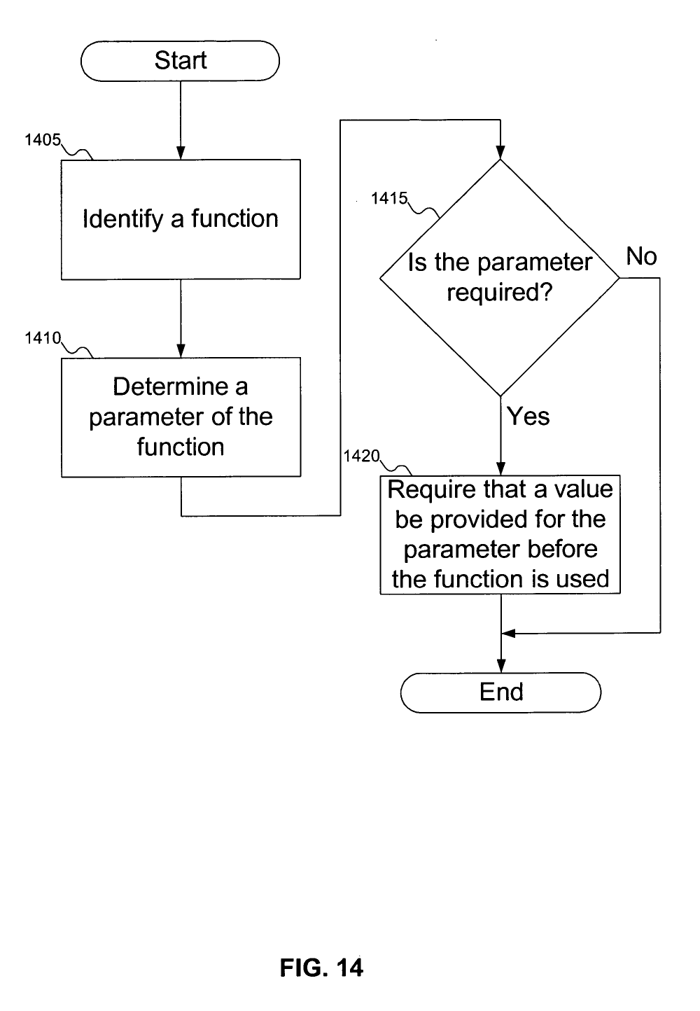

FIG. 14 shows how required parameters are enforced. At block 1405, a function is identified. At block 1410, a parameter of the function is identified. At block 1415, the parameter is checked to see if it is required. If so, then at block 1420, a value is required for the parameter before the service call is made.

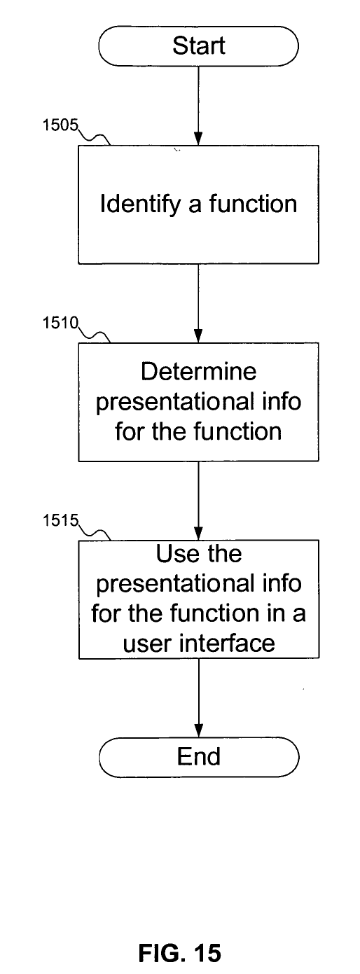

FIG. 15 shows how presentational information may be used. At block 1505, a function is identified. At block 1510, presentational information (such as grouping information, ordinal information, or positional information) for the function is determined. Finally, at block 1515, the presentational information for the function is used in a user interface.

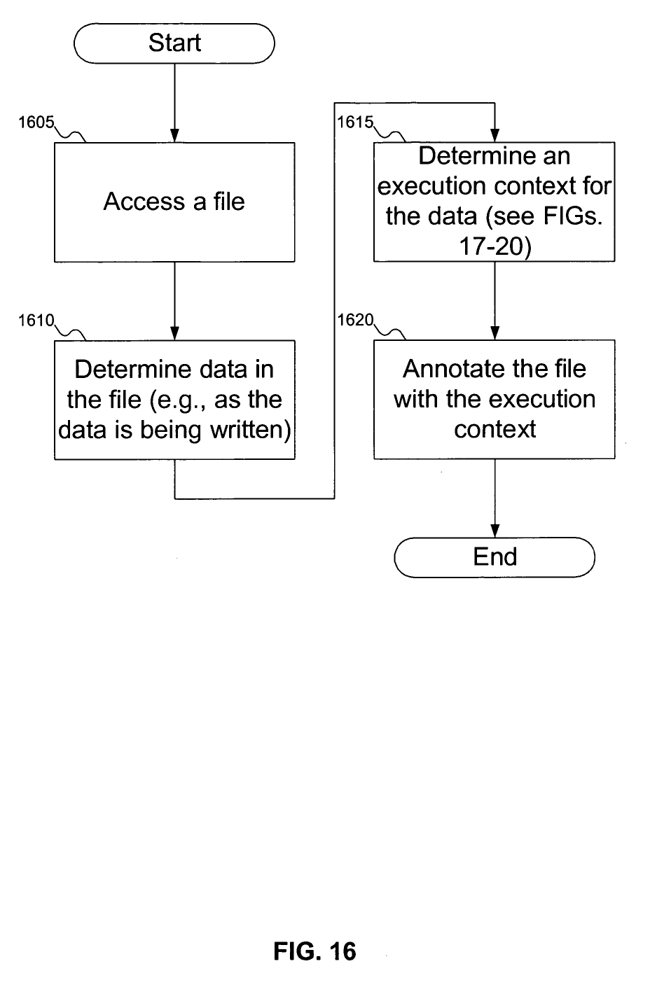

FIG. 16 shows a flowchart of the procedure for adding an execution context. Recall that SOAP clients annotate SOAP documents with execution contexts for storage in the SOAP action store. Thus, the procedure shown in FIG. 16 is typically carried out on the computer of FIG. 1. At block 1605, the computer accesses a file. At block 1610, the computer determines data in the file. This may be done in several ways: for example, as the data is generated, or after the data is complete. At block 1615, the computer determines an execution context for to the data. Finally, at block 1620, the computer annotates the data with the execution context.

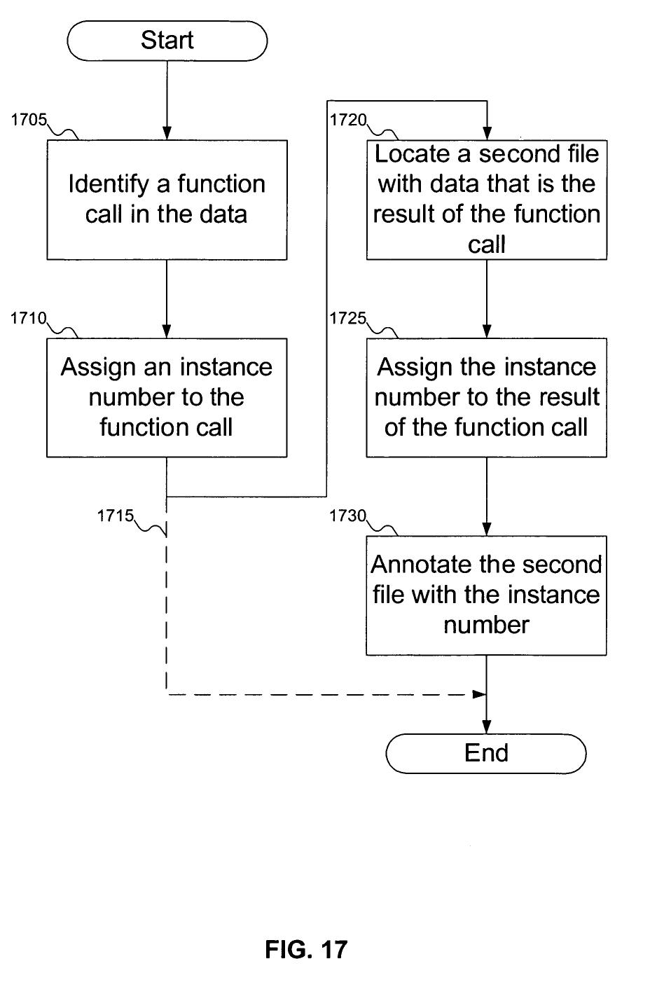

FIG. 17 shows how instance numbers are annotated. At block 1705, a function (i.e., a message) is identified. At block 1710, an instance number is assigned to the function call. At this point, the procedure may terminate, as shown by dashed arrow 1715. But because it is useful to have the same instance number matched between the SOAP action and the SOAP result, processing may continue at block 1720, where the SOAP result file is located. Then, at block 1725, the instance number is assigned to the result of the function call. Finally, at block 1730, the instance number is used to annotate the SOAP result file. (Note that FIG. 17 does not show the annotation of the SOAP action file: the annotation is described at block 1620 of FIG. 16.)

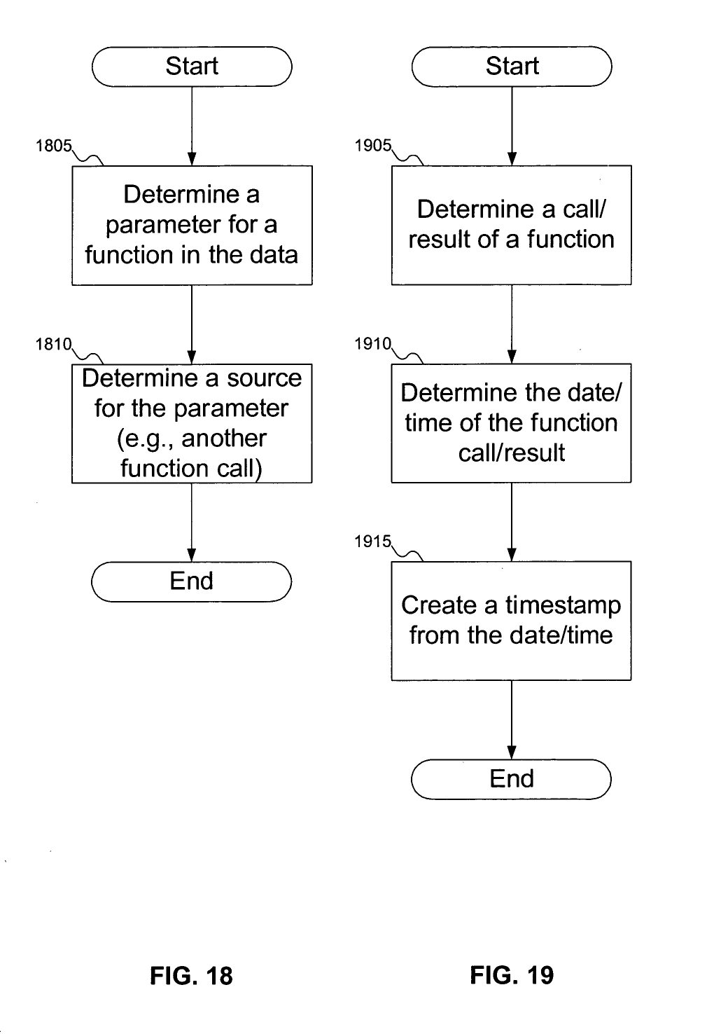

FIG. 18 shows how sources for parameters are annotated. At block 1805, a parameter of a function is identified. At block 1810, a source for the parameter is identified. This is typically accomplished by locating a parameter of an earlier SOAP result with the same value as that of the current parameter.

FIG. 19 shows how timestamps are annotated. At block 1905, a call or result of a function is determined. At block 1910, the date/time of the call or result is determined. Finally, at block 1915, a timestamp is created from the date/time of the call or result.

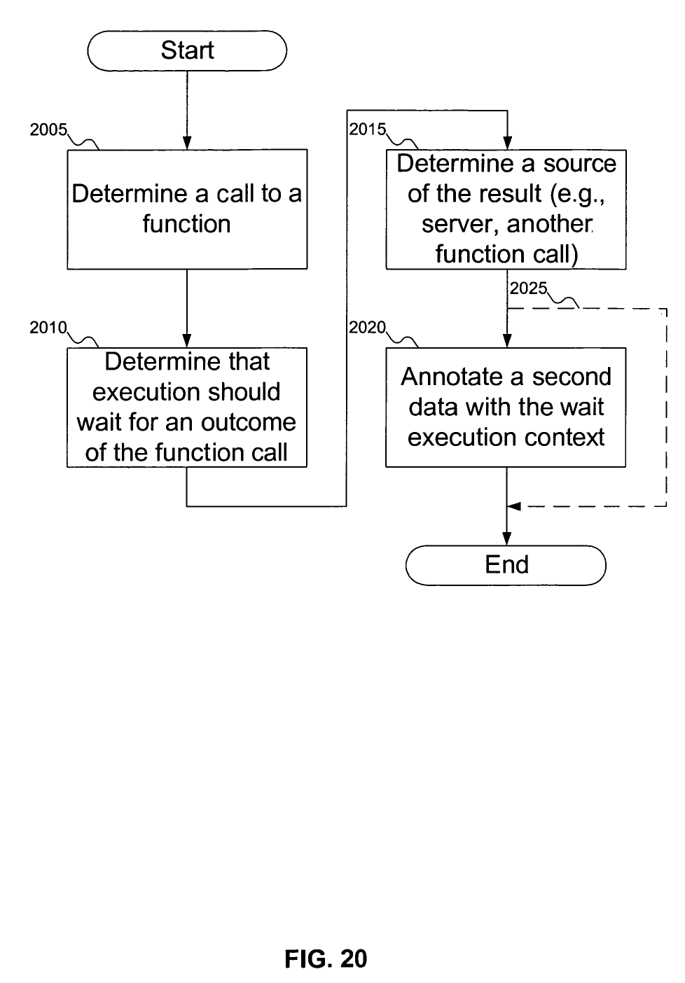

FIG. 20 shows how synchronizations are annotated. At block 2005, calls to one or more functions are determined. At block 2010, execution is determined to have to wait until notice of an outcome of the function call(s) is received. (The term “outcome” is used here to distinguish from the SOAP result received from the called SOAP server: recall that synchronization typically waits for a notice from another SOAP server that the function has been carried out.) At block 2015, the source of the notice (such as the SOAP server name or IP address, or the message used to provide the notice) is determined. Finally, at block 2020, a second data is annotated with the wait execution context.

A person skilled in the art will recognize that the wait execution context may be either annotated to a SOAP document or stored separately. For example, FIG. 8A showed execution context 805 of FIG. 8A as a separate document, but execution context 805 could just as easily have been attached to another SOAP document: for example, the SOAP action that preceded synchronization. Dashed arrow 2025 shows that block 2020 may be omitted, if the wait execution context is stored as a separate document in the SOAP action data.

The following discussion is intended to provide a brief, general description of a suitable machine in which certain aspects of the invention may be implemented. Typically, the machine includes a system bus to which is attached processors, memory, e.g., random access memory (RAM), read-only memory (ROM), or other state preserving medium, storage devices, a video interface, and input/output interface ports. The machine may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine may include embedded controllers, such as programmable or non-programmable logic devices or arrays, Application Specific Integrated Circuits, embedded computers, smart cards, and the like. The machine may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciated that network communication may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

The invention may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles. And though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A system, comprising:
a computer;
a file on the computer, the file including:
data; and
a semantic context applicable to the data; and
an enforcer on the computer to enforce that a use of the data complies with the semantic context.

2. A system according to claim 1, wherein:
the data include a first function; and
the semantic context identifies a second function upon which the first function depends.

3. A system according to claim 1, wherein:
the data include a parameter for a first function; and
the semantic context identifies a second function upon which the parameter depends.

4. A system according to claim 1, wherein:
the data include a parameter for a first function; and
the semantic context includes a list of acceptable values for the parameter.

5. A system according to claim 1, wherein:
the data include a parameter for a first function; and
the semantic context includes a range of acceptable values for the parameter.

6. A system according to claim 1, wherein the semantic context includes information to present the data in a user interface.

7. A system, comprising:
a first computer;
a file on the first computer, the file including data; and
a recorder to record an execution context for the file.

8. A system according to claim 7, wherein:
the data include a call to a function; and
the recorder is operative to record in the execution context an instance number assigned to the call to the function.

9. A system according to claim 8, wherein:
the system includes a second file on the first computer, the second file including second data including a result of the call to the function; and
the recorder is operative to record in a second execution context for the second file the instance number.

10. A system according to claim 7, wherein:
the data include a call to a function; and
the recorder is operative to record a source for a parameter in the call to the function.

11. A system according to claim 10 wherein the source for the parameter includes at least one of the following: a second call to a second function; an instance number assigned to the second call to the second function; a result of the second call to the second function; and, a reference to a second parameter of the result of the second call to the second function.

12. A system according to claim 7, wherein:
the data include a call to a function; and
the recorder is operative to record an indicator that an execution of the data should wait for a result of the call to the function.

13. A system according to claim 12, wherein the indicator includes a source for the result.

14. A system according to claim 13, wherein the source for the result includes a server from which the result should originate.

15. A system according to claim 13, wherein the source for the result includes at least one of the following: a second call to a second function; an instance number assigned to the second call to the second function; a second result of the second call to the second function; and, a reference to a second parameter of the second result of the second call to the second function.

16. A system according to claim 12, wherein the result includes a message.

17. A system according to claim 16, wherein the message includes an instance number.

18. A system according to claim 12, wherein the recorder is operative to record the indicator in a second data.

19. A memory for storing data accessible by an application program being executed on a machine, comprising:
a file structure stored in the memory, the file structure including:
data; and
a context applicable to the data in the file structure.

20. A memory according to claim 19, wherein the context includes a semantic context applicable to the data in the file structure.

21. A memory according to claim 19, wherein the context includes an execution context applicable to the data in the file structure.

22. A method for using a semantic context of a file on a computer, comprising:
accessing data from the file;
accessing a semantic context applicable to the data; and
enforcing that a use of the data complies with the semantic context.

23. A method according to claim 22, wherein:
accessing data includes identifying a parameter for a first function in the data;
accessing a semantic context includes determining a second function upon which the parameter depends; and
enforcing that a use of the data complies with the semantic context includes using the second function before using the parameter.

24. A method according to claim 22, wherein:
accessing data includes identifying a parameter for a first function in the data;
accessing a semantic context includes determining a list of acceptable values for the parameter; and
enforcing that a use of the data complies with the semantic context includes enforcing that a value for the parameter of the data is within the list of acceptable values.

25. A method for annotating a file, comprising:
determining data in the file;
determining an execution context for the data; and
annotating the file with the execution context.

26. A method according to claim 25, wherein:
determining data includes determining a parameter for a function in the data; and
determining an execution context includes determining a source for the parameter.

27. A method according to claim 26, wherein determining a source includes determining the source for the parameter as at least one of the following: a second call to a second function; an instance number assigned to the second call to the second function; a result of the second call to the second function; and, a reference to a second parameter of the result of the second call to the second function.

28. A method according to claim 25, wherein:
determining data includes determining a call to a function in the data; and
determining an execution context includes determining that an execution of the data should wait for a result of the call to the function.

29. An article comprising:
a storage medium, said storage medium having stored thereon instructions, that, when executed by a machine, result in:
accessing data from a file;
accessing a semantic context applicable to the data; and
enforcing that a use of the data complies with the semantic context.

30. An article according to claim 29, wherein:
accessing data includes identifying a first function in the data;
accessing a semantic context includes determining a second function upon which the first function depends; and
enforcing that a use of the data complies with the semantic context includes using the second function before using the first function.

31. An article according to claim 29, wherein:
accessing data includes identifying a parameter for a first function in the data;
accessing a semantic context includes determining a second function upon which the parameter depends; and
enforcing that a use of the data complies with the semantic context includes using the second function before using the parameter.

32. An article comprising:
a storage medium, said storage medium having stored thereon instructions, that, when executed by a machine, result in:
determining data in a file;
determining an execution context for the data; and
annotating the file with the execution context.

33. An article according to claim 32, wherein:
determining data includes determining a parameter for a function in the data; and
determining an execution context includes determining a source for the parameter.

34. An article according to claim 33, wherein determining a source includes determining the source for the parameter as at least one of the following: a second call to a second function; an instance number assigned to the second call to the second function; a result of the second call to the second function; and, a reference to a second parameter of the result of the second call to the second function.

35. An article according to claim 32, wherein:
determining data includes determining a call to a function in the data; and
determining an execution context includes determining that an execution of the data should wait for a result of the call to the function.
